(19) United States
(12) Patent Application Publication
(10) Pub. No.: US 2025/0214538 A1
(43) Pub. Date: Jul. 3, 2025

(54) END CAP OF A WIPER BLADE FOR A VEHICLE

(71) Applicant: VALEO SYSTEMES D'ESSUYAGE, La Verriere (FR)

(72) Inventors: Vincent GAUCHER, La Verriere (FR); Philippe BILLOT, La Verrière (FR)

(73) Assignee: VALEO SYSTEMES D'ESSUYAGE, La Verriere (FR)

(21) Appl. No.: 18/850,639

(22) PCT Filed: Mar. 14, 2023
(86) PCT No.: PCT/EP2023/056470

§ 371 Date: Sep. 25, 2024

(30) Foreign Application Priority Data
Mar. 31, 2022 (FR) FR2202971

(51) Int. Cl. B60S 1/38

(52) U.S. Cl. CPC B60S 1/3894; B60S 1/3806

(57) ABSTRACT

The invention relates to an endpiece of a wiper for a vehicle, this endpiece being arranged to be mounted at an end of a longitudinal frame which bears a scraper blade for cleaning a glazed surface, the endpiece having a first zone which is arranged to receive an end portion of the longitudinal frame and includes a first aerodynamic profile and a second zone which includes a second aerodynamic profile, this second zone being arranged such that the end portion of the longitudinal frame received in the first zone is set back from this second zone, and that the first aerodynamic profile of the first zone is different from the second aerodynamic profile of the second zone.

### TECHNICAL FIELD

The invention notably relates to an endpiece and to a wiper for a vehicle.

The vehicle may be a land vehicle, marine vehicle or air vehicle. The vehicle is, for example, a motor vehicle that travels on roads.

The invention notably applies to the wiping of a glazed surface such as a windshield.

### BACKGROUND OF THE INVENTION

As is known, wiper systems for motor vehicles comprise at least one drive arm and one wiper which has a scraper blade intended to bear against a glazed surface of the motor vehicle. The drive arm is driven in an angular back-and-forth movement against the glazed surface of the motor vehicle, during which it drives the wiper and its scraper blade such that the latter rubs the glazed surface and removes from it the water, dirt and dust that can impair the view the driver of the motor vehicle has of their surroundings.

As is known, the wiper is attached to the drive arm by a connection assembly which comprises a connector secured to the wiper and an adapter configured to cooperate with the wiper and with a terminal part of the drive arm. This connection assembly is configured both to enable the back-and-forth movements of the scraper blade against the glazed surface in question and to ensure the scraper blade is pressed against the glazed surface effectively in order to perform effective wiping and/or cleaning.

A drawback of the known wiper systems is linked to the lack of uniformity and effectiveness of the wiping and/or of the cleaning over the entire length of the scraper blade, and more particularly at a longitudinal end where potentially poor pressing of the scraper blade against the surface to be cleaned may result in a wiping defect.

The object of the present invention is notably to remedy this drawback.

### SUMMARY OF THE INVENTION

A subject of the invention is thus an endpiece of a wiper for a vehicle, this endpiece being arranged to be mounted at an end of a longitudinal frame which bears a scraper blade for cleaning a glazed surface, the endpiece having a first zone which is arranged to receive an end portion of the longitudinal frame and comprises a first aerodynamic profile and a second zone which comprises a second aerodynamic profile, this second zone being arranged such that the end portion of the longitudinal frame received in the first zone is set back from this second zone, characterized in that the first aerodynamic profile of the first zone is different from the second aerodynamic profile of the second zone.

Thus, located in succession on the wiper are a main aerodynamic profile of the longitudinal frame and, in the extension of this main aerodynamic profile, the first and second aerodynamic profiles of the endpiece which ensure that the wiper is pressed against the glazed surface over the entire length thereof, including at the end thereof where the endpiece is located.

The invention thus enables wiping which is effective over the entire length of the wiper, including at the ends thereof where, in the known devices, there is risk of detachment of the scraper blade.

It will be appreciated that the first and second aerodynamic profiles of the endpiece each have a surface profile (called “downforce-generating” surface profile) such that a pressing force is applied over the entire length of the endpiece against the glazed surface.

According to one of the aspects of the invention, the endpiece has a step between the first zone and the second zone.

According to one of the aspects of the invention, the step is straight. Notably, this step is a planar surface perpendicular to a longitudinal direction of the wiper.

According to one of the aspects of the invention, in the first zone, the endpiece has sufficient dimensions to be able to envelop the end portion of the longitudinal frame, including a main aerodynamic profile of the frame, such that the endpiece, in this first zone, has an outer periphery which is greater than the main aerodynamic profile of the frame. This outer periphery of the endpiece is thus not in the extension of the main aerodynamic profile.

According to one of the aspects of the invention, the first zone of the endpiece has a form that envelops the form of the end portion of the longitudinal frame.

According to one of the aspects of the invention, the end portion of the longitudinal frame extends in the endpiece as far as the step, namely in the first zone and without crossing over into the second zone.

This frame is notably produced by extrusion of a plastics material.

According to one of the aspects of the invention, after the step, in the second zone, the periphery of the endpiece is reduced with respect to the periphery in the first zone such that the second aerodynamic profile is substantially in the extension of the main aerodynamic profile.

According to one of the aspects of the invention, the endpiece has an insertion side which is provided with an insertion opening arranged to allow the insertion of the longitudinal frame into the endpiece.

According to one of the aspects of the invention, the endpiece has a hollow body forming the first zone, which is open toward the second zone, which is closed at the terminal end thereof.

According to one of the aspects of the invention, the first zone and the second zone share a common bottom wall facing the glazed surface.

According to one of the aspects of the invention, the first zone is arranged to receive the end portion of the longitudinal frame and comprises a first upper wall for receiving the end portion of the longitudinal frame, this upper wall facing the common bottom wall, and this first upper wall forms the first aerodynamic profile.

According to one of the aspects of the invention, the second zone of the endpiece comprises a second upper wall facing the common bottom wall and forming the second aerodynamic profile.

According to one of the aspects of the invention, the height of the first zone is greater than the height of the second zone, the height of the first zone being the vertical distance measured between the bottom wall and a point of the first receiving upper wall, the height of the second zone being the vertical distance measured between the bottom wall and a point of the second upper wall.

In other words, along any straight line that is perpendicular to the bottom wall of the endpiece and intersects the first and second zones, the point of intersection with the first zone is at a greater height than the height of the point of intersection of this straight line with the second zone.

According to one of the aspects of the invention, the longitudinal distance between the insertion opening and the step of the endpiece, for example a distance of less than 10 mm, is smaller than the longitudinal distance between this step and the terminal end of the endpiece. This distance is between 5 and 6 mm, for example.

In other words, the first zone has a smaller length than the length of the second zone, these lengths being measured in the longitudinal direction of the wiper.

Thus, the second aerodynamic profile extends longitudinally over the majority of the endpiece, making it possible to have a satisfactory aerodynamic thrust for pressing the wiper onto the glazed surface.

For example, the first zone has a length smaller than half, or one quarter, or one fifth, of the length of the second zone.

According to one of the aspects of the invention, the endpiece comprises an aerodynamic leading edge, and the first and second aerodynamic profiles extend from this edge.

According to one of the aspects of the invention, the first aerodynamic profile has a greater slope than the slope of the second aerodynamic profile, at least over a region adjacent to the leading edge.

The slope is measured by an angle between a plane parallel to the bottom wall of the endpiece and the aerodynamic profile.

According to one of the aspects of the invention, the second aerodynamic profile comprises a region with a first slope which extends from the leading edge as far as a region with a second slope, this second slope being greater than the first slope.

According to one of the aspects of the invention, the region with the first slope is locally planar.

According to one of the aspects of the invention, the region with the first slope is planar over the majority of the total surface area thereof.

According to one of the aspects of the invention, the slope angle of the region with the first slope is between 0° and 45°, notably between 10° and 30°.

According to one of the aspects of the invention, the slope angle of the region with the second slope is between 45° and 90°, notably between 70° and 90°.

According to one of the aspects of the invention, the slope angle in the region with the second slope varies with progressively increasing distance away from the region with the first slope.

According to one of the aspects of the invention, the region with the second slope connects to the region with the first slope by forming a curved profile so as to improve the aerodynamics.

According to one of the aspects of the invention, the region with the second slope is formed on a raised fin of the endpiece and the region with the first slope is formed on a base of the endpiece.

According to one of the aspects of the invention, the base is formed by the hollow body.

According to one of the aspects of the invention, the fin of the endpiece is formed by a solid wall of the endpiece.

The solid wall is thus less thick than a double wall, for example in the shape of a U.

Thus, by virtue of this reduced thickness, the fin of the endpiece can thus be placed relatively rearward of the leading edge so as to offer the largest possible aerodynamic surface.

According to one of the aspects of the invention, the fin has a crest line which is rectilinear, between the step and the terminal end of the endpiece.

This crest line forms the apex of this fin.

In a variant, the fin has a crest line which is curved, between the step and the terminal end of the endpiece.

For example, this curved crest line approaches the leading edge of the endpiece as one moves from the step toward the terminal end of the endpiece.

According to one of the aspects of the invention, the height of the second aerodynamic profile is substantially constant between the step and the terminal end of the endpiece.

According to one of the aspects of the invention, the height of the first zone is greater than the height of the second zone so as to form the step.

The height of the fin may be constant or increasing or decreasing, between the step and the terminal end of the endpiece.

According to one of the aspects of the invention, the endpiece has a rear face, on the opposite side to the leading edge, provided with a concave zone whose concavity is directed toward the exterior of the wiper, this concave zone being situated at the junction between the fin and the base.

According to one of the aspects of the invention, the endpiece is made of plastics material, notably as a single piece.

A further subject of the invention is a wiper comprising a scraper blade, a longitudinal frame with a main aerodynamic profile, to which frame the scraper blade is secured, and an endpiece as described above, this endpiece being mounted at the end of the longitudinal frame.

According to one of the aspects of the invention, the second aerodynamic profile of the endpiece has a form which is substantially in the extension of the form of the main aerodynamic profile of the longitudinal frame.

According to one of the aspects of the invention, the wiper comprises two endpieces as described above, each being mounted at one of the two ends of the longitudinal frame.

In a variant, the wiper comprises a single endpiece as described above, mounted at one of the two ends of the longitudinal frame.

A further subject of the invention is a wiper system for a glazed surface of a vehicle, the wiper system comprising:
a wiper as described above, the wiper being intended to be brought into contact with the glazed surface,
a wiper arm configured to drive the wiper,
a connection device configured to securely fix the wiper to the wiper arm.

### BRIEF DESCRIPTION OF DRAWINGS

Other features and advantages of the invention will become more clearly apparent both from the following description and from exemplary embodiments, which are given by way of non-limiting indication with reference to the attached schematic drawings, in which:

FIG. 1 illustrates a perspective view of an exemplary embodiment of a wiper according to an exemplary embodiment of the invention;

FIG. 2 illustrates a perspective view of an endpiece of the wiper in FIG. 1;

FIG. 3 illustrates a view in profile of the end portion of the frame of the wiper in FIG. 1;

FIG. 4 illustrates a view in profile of the endpiece in FIG. 1.

### DETAILED DESCRIPTION OF THE INVENTION

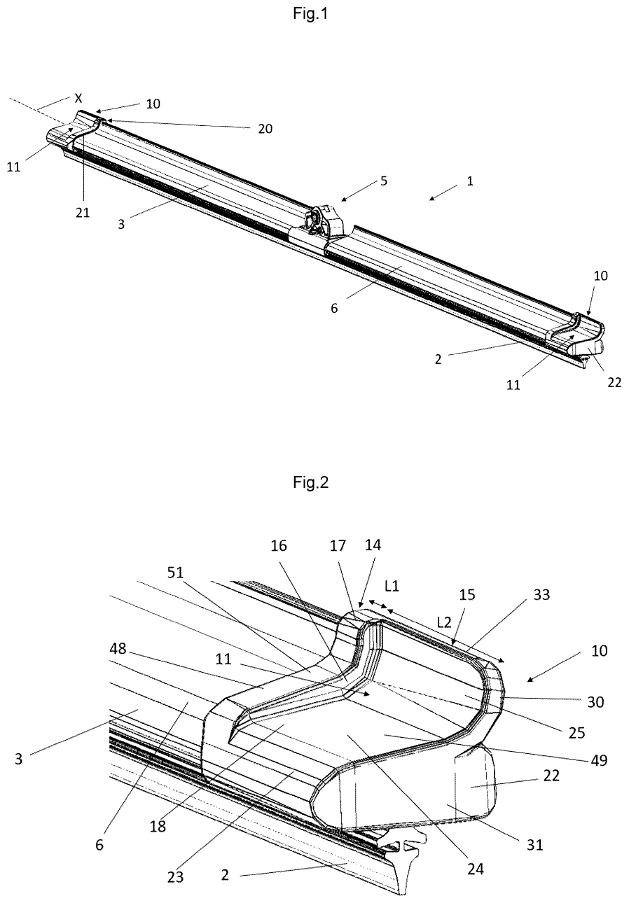

FIG. 1 illustrates a wiper 1 according to an exemplary embodiment of the invention.

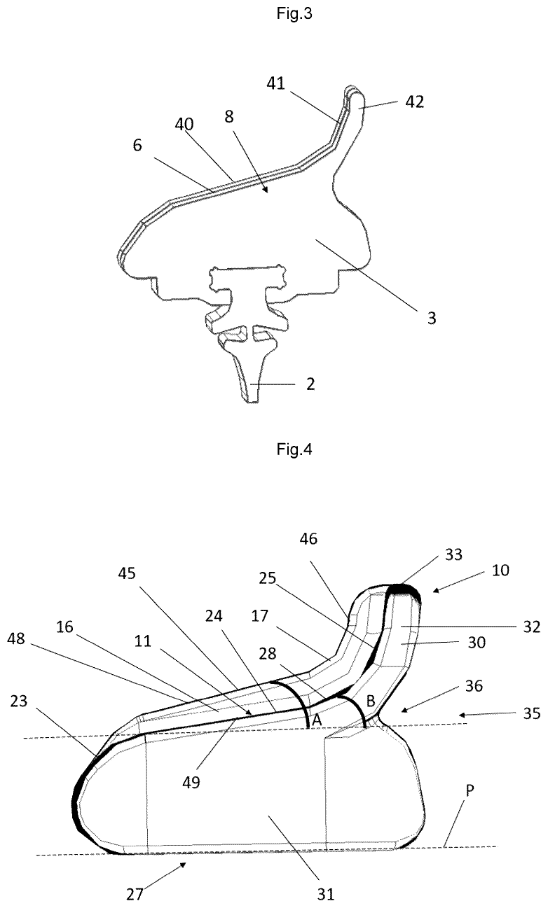

This wiper 1 comprises a scraper blade 2, a longitudinal frame 3 to which the scraper blade 2 is secured and two endpieces 10 with a longitudinal main orientation according to an exemplary embodiment of the invention, as visible in FIG. 3.

This frame 3 is notably produced by extrusion of a plastics material.

Each endpiece 10 is mounted at one of the ends of the longitudinal frame 3.

This wiper 1 is used in a wiper system for a glazed surface of a vehicle, by being mounted on a wiper arm by way of a connection device 5 configured to securely fix the wiper 1 to the wiper arm (not shown).

The longitudinal frame 3 comprises a main aerodynamic profile 6 arranged such that a relative wind, produced by the movement of the vehicle, produces a force that tends to press the wiper 1 onto the glazed surface.

As illustrated notably in FIG. 2, the endpiece 10 has a first zone 14, which is arranged to receive an end portion 8 of the longitudinal frame 3 and comprises a first aerodynamic profile 17, and a second zone 15 which comprises a second aerodynamic profile 11, this second zone 15 being arranged such that the end portion 8 of the longitudinal frame 3 received in the first zone 14 is set back from this second zone 15.

The first aerodynamic profile 17 of the first zone 14 is different from the second aerodynamic profile 11 of the second zone 15.

The second aerodynamic profile 11 is substantially in the extension of the main aerodynamic profile 6 of the longitudinal frame 3.

The first zone 14 comprises a first upper wall 48 for receiving the end portion 8 of the longitudinal frame, this first upper wall 48 facing a common bottom wall 27.

The second zone 15 of the endpiece comprises a second upper wall 49 facing the common bottom wall 27 and forming the second aerodynamic profile 11.

The endpiece 10 has a straight step 16 between the first zone 14 and the second zone 15.

In the first zone 14, the endpiece 10 has sufficient dimensions to be able to envelop the end portion 8 of the longitudinal frame 2, including the main aerodynamic profile 6, such that the endpiece 10, in this first zone 14, has a first aerodynamic profile 17 which is greater than the main aerodynamic profile 6. Thus, this first aerodynamic profile 17 of the endpiece 10 is not in the extension of the main aerodynamic profile 6, as can be seen in FIG. 2, in particular.

The end portion 8 of the longitudinal frame 3 extends in the endpiece 10 as far as the step 16, namely in the first zone 14 and without crossing over into the second zone 15.

After the step 16, in the second zone 15, the periphery 18 of the endpiece is reduced with respect to the periphery in the first zone 14 such that the second aerodynamic profile 11 is in the extension of the main aerodynamic profile 6.

The endpiece 10 has an insertion side 20 which is provided with a lateral insertion opening 21 arranged to allow the insertion of the longitudinal frame 3 into the endpiece 10.

The longitudinal distance between the lateral insertion opening 21 and the step 16 of the endpiece 10, for example a distance of less than 10 mm, is smaller than the longitudinal distance between this step 16 and the terminal end 22 of the endpiece 10. This distance is between 5 and 6 mm, for example.

In other words, the first zone 14 has a smaller length L1 than the length L2 of the second zone 15, these lengths being measured in the longitudinal direction X of the wiper 1.

Thus, the second aerodynamic profile 11 extends over the majority of the endpiece 10, making it possible to have a satisfactory aerodynamic thrust for pressing the wiper 1 onto the glazed surface.

The endpiece 10 comprises an aerodynamic leading edge 23, and the first and second aerodynamic profiles 17 and 11 extend from this edge 23.

The second aerodynamic profile 11 comprises a region 24 with a first slope which extends from the leading edge 23 as far as a region 25 with a second slope, as can be seen for example in FIG. 4.

The slope corresponds to the angle B between, for the one part, a plane P adjacent to the bottom wall 27 of the endpiece 10, said bottom wall facing the scraper blade 2, and, for the other part, the second aerodynamic profile 11 comprising the regions 24 or 25.

The region 24 with the first slope is planar and inclined over the majority of the total surface area thereof.

The slope angle B of the region 24 with the first slope is between 0° and 45°, notably between 10° and 30°.

The slope angle of the region 25 with the second slope is between 45° and 90°, notably between 70° and 90°.

The slope angle in the region 25 with the second slope varies with progressively increasing distance away from the region 24 with the first slope. Thus, this region 25 with the second slope straightens out more and more with increasing distance away from the region 24 with the first slope.

The region 25 with the second slope connects to the region 24 with the first slope by forming a curved profile 28 so as to improve the aerodynamics.

The region 25 with the second slope is formed on a raised fin 30 of the endpiece 10 and the region 24 with the first slope is formed on a base 31 of the endpiece 10.

The first aerodynamic profile 17 comprises a region 45 with a first slope which extends from the leading edge 23 as far as a region 46 with a second slope, as can be seen for example in FIG. 4. The second slope is greater than the first slope.

The slope corresponds to the angle A between, for the one part, the plane P adjacent to the bottom wall 27 of the endpiece 10, said bottom wall facing the scraper blade 2, and, for the other part, the first aerodynamic profile 17.

The height of the first zone 14 is greater than the height of the second zone 15, the height of the first zone 14 being the vertical distance measured between the plane P adjacent to the bottom wall 27 and a point of the first receiving upper wall 48, the height of the second zone 15 being the vertical distance measured between the bottom wall 27 and a point of the second upper wall 49.

In other words, along any straight line that is perpendicular to the bottom wall P of the endpiece and intersects the first and second zones 14 and 15, the point of intersection with the first zone 14 is at a greater height than the height of the point of intersection of this straight line with the second zone 15.

The step 16 between the zones 14 and 15 has a height of approximately 2 mm, for example.

The main aerodynamic profile 6 has, like the second aerodynamic profile 11, a region 40 with a first slope extended by a region 41 with a greater slope formed on a fin 42.

The base 31 of the endpiece 10 is formed by a hollow body 51.

The fin 30 of the endpiece 10 is formed by a solid wall 32.

The fin 30 of the endpiece 10 can thus be placed relatively rearward of the leading edge 23 so as to offer the largest possible aerodynamic surface.

The fin 30 has a crest line 33 which is rectilinear, between the step 16 and the terminal end 22 of the endpiece 10.

This crest line 33 forms the apex of this fin 30.

In a variant, the fin 30 has a crest line 33 which is curved, between the step 16 and the terminal end 22 of the endpiece 10.

For example, this curved crest line 33 approaches the leading edge 23 of the endpiece as one moves from the step 16 toward the terminal end 22 of the endpiece 10.

The height of the second aerodynamic profile 11 is substantially constant between the step 16 and the terminal end 22 of the endpiece 10.

The height of the fin 30 may be constant or increasing or decreasing, between the step 16 and the terminal end 22 of the endpiece 10.

The endpiece 10 has a rear face 35, on the opposite side to the leading edge 23, provided with a concave zone 36 whose concavity is directed toward the exterior of the wiper, this concave zone 36 being situated at the junction between the fin 30 and the base 31.

The endpiece 10 is made of plastics material, notably as a single piece.

What is claimed is:

1. An endpiece of a wiper for a vehicle, the endpiece being arranged to be mounted at an end of a longitudinal frame which bears a scraper blade for cleaning a glazed surface, the endpiece comprising a first zone which is arranged to receive an end portion of the longitudinal frame and includes a first aerodynamic profile and a second zone which includes a second aerodynamic profile, the second zone being arranged such that the end portion of the longitudinal frame received in the first zone is set back from the second zone, and the first aerodynamic profile of the first zone being different from the second aerodynamic profile of the second zone.

2. The endpiece as claimed in claim 1, including a step between the first zone and the second zone.

3. The endpiece as claimed in claim 1, wherein the first zone has a smaller length than a length of the second zone, these lengths being measured in a longitudinal direction of the wiper.

4. The endpiece as claimed in claim 1, wherein the endpiece includes an aerodynamic leading edge, and the first and second aerodynamic profiles extend from the aerodynamic leading edge.

5. The endpiece as claimed in claim 4, wherein the second aerodynamic profile includes a first region with a first slope which extends from the aerodynamic leading edge and a second region with a second slope, with the second slope being greater than the first slope.

6. The endpiece as claimed in claim 5, wherein the first region is locally planar.

7. The endpiece as claimed in claim 5, wherein the second region is formed on a raised fin of the endpiece and the first region is formed on a base of the endpiece.

8. The endpiece as claimed in claim 7, wherein the fin of the endpiece is formed by a solid wall of the endpiece.

9. The endpiece as claimed in claim 7, wherein the endpiece has a rear face, on the opposite side to the leading edge, provided with a concave zone whose concavity is directed toward the exterior of the wiper, the concave zone being situated at the junction between the fin and the base.

10. A wiper comprising a scraper blade, a longitudinal frame to which the scrapper blade is secured and an endpiece being mounted at the end of the longitudinal frame, with the endpiece including a first zone which is arranged to receive an end portion of the longitudinal frame and includes a first aerodynamic profile and a second zone which includes a second aerodynamic profile, the second zone being arranged such that the end portion of the longitudinal frame received in the first zone is set back from the second zone, and the first aerodynamic profile of the first zone being different from the second aerodynamic profile of the second zone.
